(19) United States
(12) Patent Application Publication
(10) Pub. No.: US 2016/0342141 A1
(43) Pub. Date: Nov. 24, 2016

(54) TRANSPARENT CAPACITIVE TOUCHSCREEN DEVICE OVERLYING A MECHANICAL COMPONENT

(71) Applicant: Fahad Koumaiha, Troy, MI (US)

(72) Inventor: Fahad Koumaiha, Troy, MI (US)

(21) Appl. No.: 15/225,987

(22) Filed: Aug. 2, 2016

Related U.S. Application Data
(63) Continuation of application No. 14/258,773, filed on Apr. 22, 2014, now abandoned.

(51) Int. Cl. G04G 21/08; G04G 9/00

(52) U.S. Cl. CPC G04G 21/08; G04G 9/0064

(57) ABSTRACT

An analog timepiece with smart watch functions is provided that has an overlay full color display and a transparent mode when the smart watch features are not in use. The transparent display mode exposes the underlying analog watch, which operates on a separate power supply then the smart watch functions and display. The analog watch may operate on a traditional winding, long life battery, solar charge, pendulum drive, or a self-winding drive based on watch motion. The smart watch functions operate on a rechargeable battery designed for frequent recharging. In a specific embodiment, recharging of the rechargeable battery may be with an induction mat. The full complement of smart watch functions provided by embodiments of the overlay smart watch display differ from existing analog digital watches that have an analog movement with a smaller digital display on the watch face to show time, dates, or a chronograph.

### RELATED APPLICATIONS

This application is a continuation of U.S. non-provisional application Ser. No. 14/258,773 filed Apr. 22, 2014; the contents of which are hereby incorporated by reference.

### FIELD OF THE INVENTION

The present invention in general relates to the field of wearable electronics and in particular to an analog movement watch with a transparent display overlay to provide smart watch functions.

### BACKGROUND OF THE INVENTION

Wearable technology, wearable devices, or fashion electronics are clothing and accessories incorporating computer and advanced electronic technologies. A popular wearable device is the smart watch, which is a computerized wristwatch with functionality that is enhanced beyond timekeeping, and is often comparable to a personal digital assistant (PDA) device. Smart watches can perform basic tasks, such as calculations, translations, and game-playing, while more advanced smart watches run mobile apps, and run a mobile operating system and function as portable media players, offering playback of FM radio, audio, and video files to the user via a Bluetooth headset. Some smartphone models, (also called watch phones) feature full mobile phone capability, and can make or answer phone calls. Further features that may be available on a smart watch include a camera, accelerometer, thermometer, altimeter, barometer, compass, chronograph, GPS navigation, map display, graphical display, scheduler, heart rate monitor, and other fitness trackers.

Smart watches generally employ a touchscreen to control the functions available on the watch. A touchscreen is an electronic visual display that the user can control through simple or multi-touch gestures by touching the screen with a special stylus/pen and-or one or more fingers.

A see-through display is an electronic display that allows the user to see what is shown on the glass screen while still being able to see through it. See-through displays screens can be used for augmented reality, a way of enhancing a user's view of the world with digital images overlaid onto real ones, and other applications such as shopping displays and more sophisticated computer screens.

See-through or transparent displays are generally made with organic light-emitting diodes (OLED's) or liquid-crystal display (LCD), with OLED being the most commonly produced form of see-through displays on the market or in development. OLED screens have two layers of glass on both sides of the OLED, which consist of an emissive and conductive layer. Electrical impulses travel through the conductive layer and produce light at the emissive layer. This is different from LCD's in that OLED's produce their own light, which allows the screens to be much thinner, while LCD's need to be backlit. The narrow gap between the pixels of the screen, as well as the clear cathodes within, allow the screens to be transparent. Normally, LCD displays are incapable of being see-through because of their thickness and inability to emit their own light. However, some LCD screens use natural lighting like the sun instead of electrical backlighting. The lack of a backlight allows the screens to be much thinner as well as see-through. See-though LCD screens are a cheaper alternative to OLED's, however, their use is limited because of the natural light restriction.

Numerous innovations for the wristwatch have been provided in the prior art that are described as follows. Even though these innovations may be suitable for the specific individual purposes which they address, they differ from the present design as hereinafter contrasted. The following is a summary of those prior art patents most relevant to this application at hand, as well a description outlining the difference between the features of the analog movement watch with a transparent display overlay and the prior art.

U.S. Pat. Publication No. 20110026368 of Gregg F. Relyea describes a graphic display programmable wristwatch that displays an array of downloadable static and animated images on an LCD or LED screen to be used to tell time, and more particularly to a programmable wristwatch that serves as a platform for downloadable computer generated graphic images by the means of being placed on a docking station cradle at night to charge the battery along with being able to be connected to a computer The preferred and alternate embodiments of the graphic display programmable wristwatch have several distinct and innovative elements an LCD or LED screen, a USB port and a wireless sensor port, a time-keeping unit and a central processing unit.

While the Relyea patent application describes the use of LCD or LED screens to tell time with various graphical configurations including the generation of hour and minute hands of a traditional analog movement on the display screen, the device of this application does not use an overlay full color display with a transparent mode with an underlying actual analog movement. The application also fails to disclose smart watch features that are available when the full color overlay display is in a non-transparent mode that obscures the analog movement. Thus, the application of Relyea lacks the stylistic and functional aspects disclosed herein.

U.S. Pat. No. 6.084,828 of Bland et al. describes a timepiece and chronometer with a superimposed analog/digital display arrangement. The timepiece includes a watch case with a back and a display area, a transparent crystal, an electrically-driven digital LCD display, a superimposed analog display comprising an hour hand, minute hand, and interior bezel, an electrical analog watch movement, and a digital display driver. The digital LCD display indicates passing seconds by incrementally displaying either digits 00 through 59 or digits 01 through 60 for one second each, either in dark numerals over a light background, or vice versa. The analog display is driven by an electrical watch movement located beneath the LCD display that comprises a battery, a timing standard, timing circuitry, a stem and crown assembly, and a hand moving assembly that extends upward through the center aperture of the LCD display and couples to the analog watch hands. The digital display driver also located behind the LCD display, couples to the digital LCD display and comprises a second battery, a timing standard, and timing and display driving electronic components and circuitry. The analog movement and the digital display driver may share the same electrical ground, but otherwise are electrically isolated from one another.

While the Bland et al. patent application describes the use of an LCD screen to tell seconds with a traditional analog movement superimposed over the LCD screen, the device of this patent does not use an overlay full color display with a transparent mode with an underlying actual analog movement as described hereinafter. The application also fails to disclose smart watch features that are available when the full color overlay display is in a non-transparent mode that obscures the analog movement. Thus, the patent of Bland et al. lacks the stylistic and functional aspects disclosed herein.

While smart watches offer many user conveniences, smart watches lack the classic styling of a traditional analog movement, and smart watches also suffer from the “dead” watch problem which stems from the draining of the battery and rendering the watch useless for timekeeping. Thus, there exists a need for a smart watch with classic analog styling cues that is still able to provide a timekeeping function even when the battery for the smart watch functions is depleted.

### SUMMARY OF THE INVENTION

An inventive analog timepiece with smart watch functions is provided. The smart watch functions are available on an overlay full color display with a transparent mode when the smart watch features are not in use is provided. The transparent display mode of the smart watch exposes the underlying analog watch, which operates on a separate power supply then the smart watch functions and display. The analog watch may operate on a traditional winding, long life battery, solar charge, pendulum drive, or a self-winding drive based on watch motion. The smart watch functions, which require more operational energy, operate on a rechargeable battery designed for frequent recharging. The frequency of required recharging would be based on time of use and the power intensity of the applications used in the smart watch mode. In a specific embodiment recharging of the rechargeable battery may be with an induction mat. The full complement of smart watch functions provided by embodiments of the overlay smart watch display differ from existing analog digital watches that have an analog movement with a smaller digital display on the watch face to show time, dates, or a chronograph.

### BRIEF DESCRIPTION OF THE DRAWINGS

The present invention is further detailed with respect to the following non-limiting specific embodiments of the present invention. The appended claims should not be construed as being limited to the specific devices so detailed.

FIGS. 1A and 1B are perspective views of an underlying analog watch and the overlay display in transparent mode, and the smart watch application display with the overlay display on, respectively, according to embodiments of the invention;

FIGS. 2A-2G are perspective views of the combined analog watch with the overlay display smart watch according to an embodiment of the invention;

FIGS. 3A and 3B are front elevation views showing the analog watch with the smart watch overlay in transparent mode showing color combinations according to embodiments of the invention; and

FIGS. 4A and 4E are perspective views of the smart watch overlay screen showing application modes including caller identification for cell phone, address hook, application display, fitness tracking monitor, and music player according to an embodiment of the invention.

### DETAILED DESCRIPTION OF THE INVENTION

The present invention has utility as a smart watch that provides for more reliable timekeeping by providing an analog timepiece with smart watch functions available on an overlay full color display with a transparent mode when the smart watch features are not in use. It is appreciated that the transparent display is readily applied as a data overlay on various other devices such as a vehicle instrument panel, a clock radio, a dual analog digital measurement meter or instrument; a compass; a pressure gauge(s) such as tire, propane tanks, gas/liquid; a scale (weight scales); a sphygmomanometer; a barometer/altimeter; an analog Geiger counter; and an analog electric frequency gauges.

The transparent display mode of the smart watch exposes the underlying analog watch, which operates on a separate power supply then the smart watch functions and display. The use of a user adjustable transparent overlay display provides the surprising result of the look and feel of a traditional analog timepiece with full function smart watch capabilities that are not available on previous analog timepieces.

The analog watch movement may operate on a traditional winding, long life battery, solar charge, pendulum drive, or a self-winding drive based on watch motion. The smart watch functions, which require more operational energy, operate on a rechargeable battery designed for frequent recharging. The frequency of required recharging would be based on time of use and the power intensity of the applications used in the smart watch mode. In a specific embodiment recharging of the rechargeable battery may be with an induction mat. The full complement of smart watch functions provided by embodiments of the overlay smart watch display differ from existing analog digital watches that have an analog movement with a smaller digital display on the watch face to show time, dates, or a chronograph. Embodiments of the transparent display are readily applied as a data overlay on various other devices such as a vehicle instrument panel, a clock radio, or a dual analog digital measurement meter or instrument.

Embodiments of the inventive watch employ an overlay transparent touchscreen for displaying and allowing for user selection of smart watch functions and modes of operation via touchscreen. The see-through or transparent displays may be based on existing technologies such as OLED or LCD, or other technologies without limiting the inventive aspects of the inventive overlay smart watch with an underlying analog movement. In embodiments of the inventive smart watch, the touchscreen may be a capacitive touchscreen. The shape of the watch face may be circular, oval, square, or rectangular.

Embodiments of the inventive watch combine traditional timekeeping functions with an analog movement with advance smart watch digital functions such as, but not limited to, syncing with mobile technology, monitoring vitals, geo-positioning (GPS), music player, ending/receiving calls, controlling other devices via Bluetooth/Wi-Fi/etc., sending messages (sms, email), and social networking applications and functions, Internet access, complex notification/calendar/contact system, and accelerometer/gyrometer, etc. In further embodiments of the inventive watch could also be configured as a wearable biometric measuring device (insulin sensors for diabetics for example), as a location device (for children), and as a payment method, etc.

In specific embodiments of the inventive watch, there is interfacing or coupling between the digital and analog movements so that the mechanical movements can be synced or controlled via the digital components so as to show different times, correct time, or automatically switch between time zones where applicable.

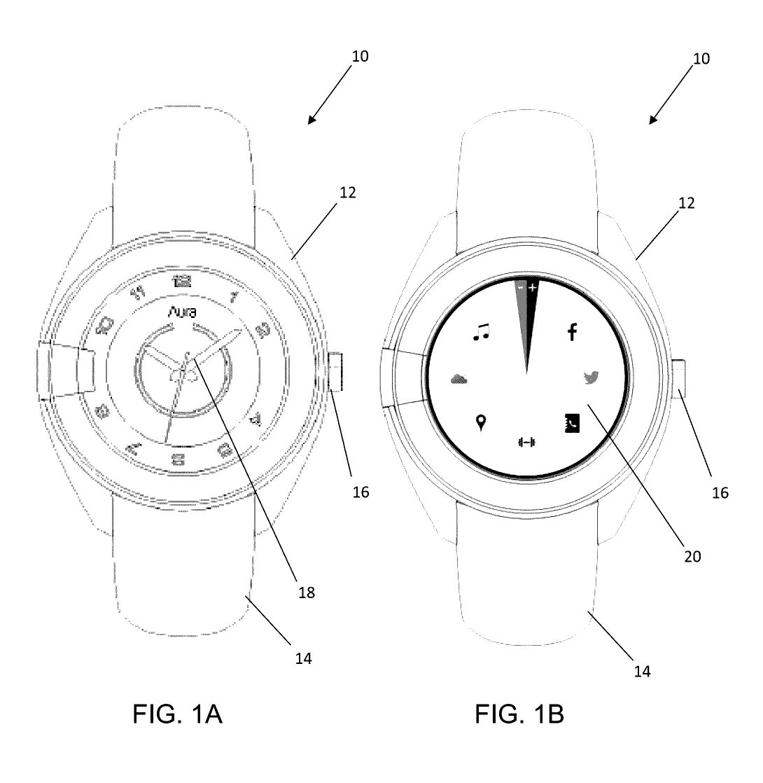

With reference to the attached figures, an inventive watch assembly is depicted generally at 10 in FIGS. 1A and 1B in perspective views of an underlying analog watch movement 18 and the overlay display in transparent mode, and the of the smart watch application display 20 with the overlay display on, respectively, according to embodiments of the invention. The watch 10 has a body 12 which houses the analog watch movement 18, and the electronics, memory storage, overlay display hardware, and batteries. Dial 16 may be used for adjusting the analog movement, as well as the intensity or phase of the display 20 from transparent, semitransparent, to full color display for using smart watch functions and applications, as well as for making selections within the smart watch applications. The dial 16 may also extend outward or be pushed inward for various functions. A band 14 for mounting the watch 10 to a user wrist is also provided.

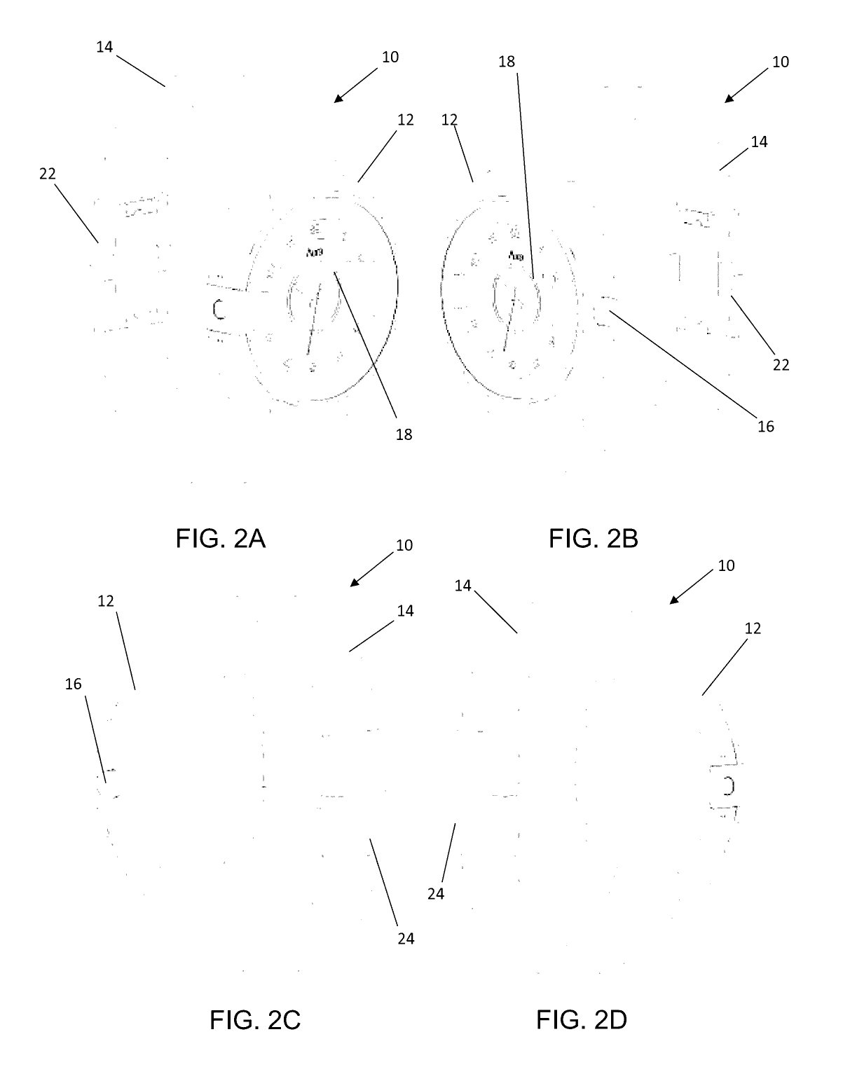

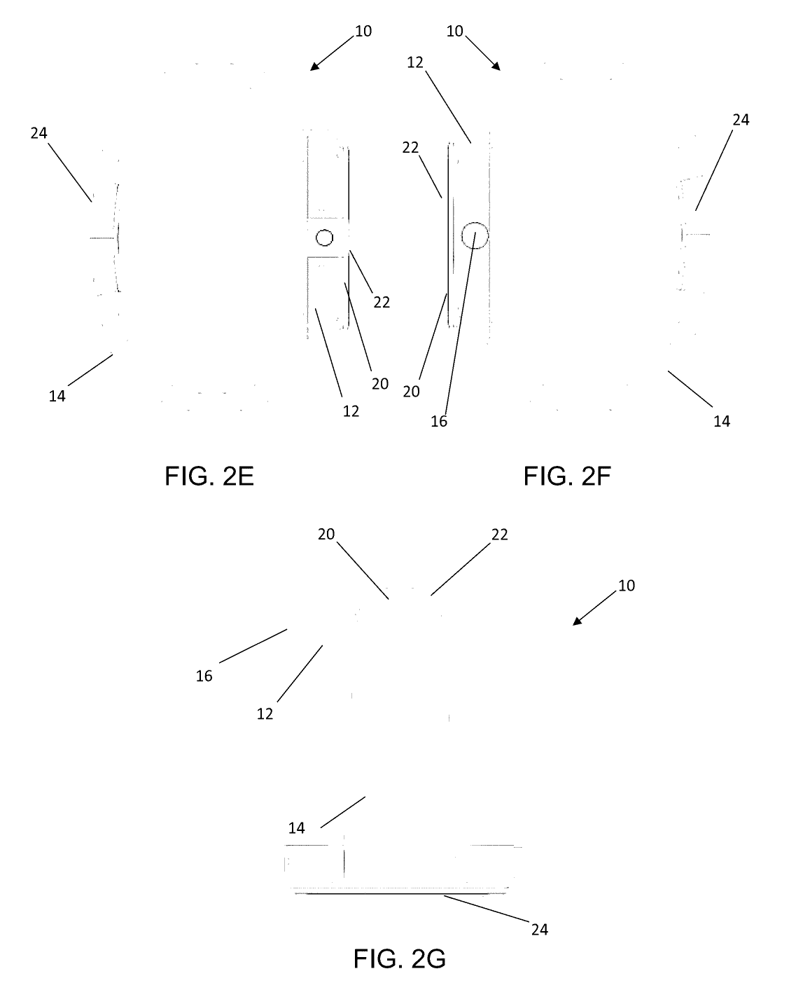

FIGS. 2A-2G are perspective views of the watch assembly 10 that combines an analog watch 18 with the overlay display 20 smart watch according to an embodiment of the invention. As better shown in FIGS. 2A-2G the band 14 has a rear clasp 24 for securing the band 14, and a watch crystal or lense 22 for sealing the analog movement 18 and overlay display 20 to the body 12.

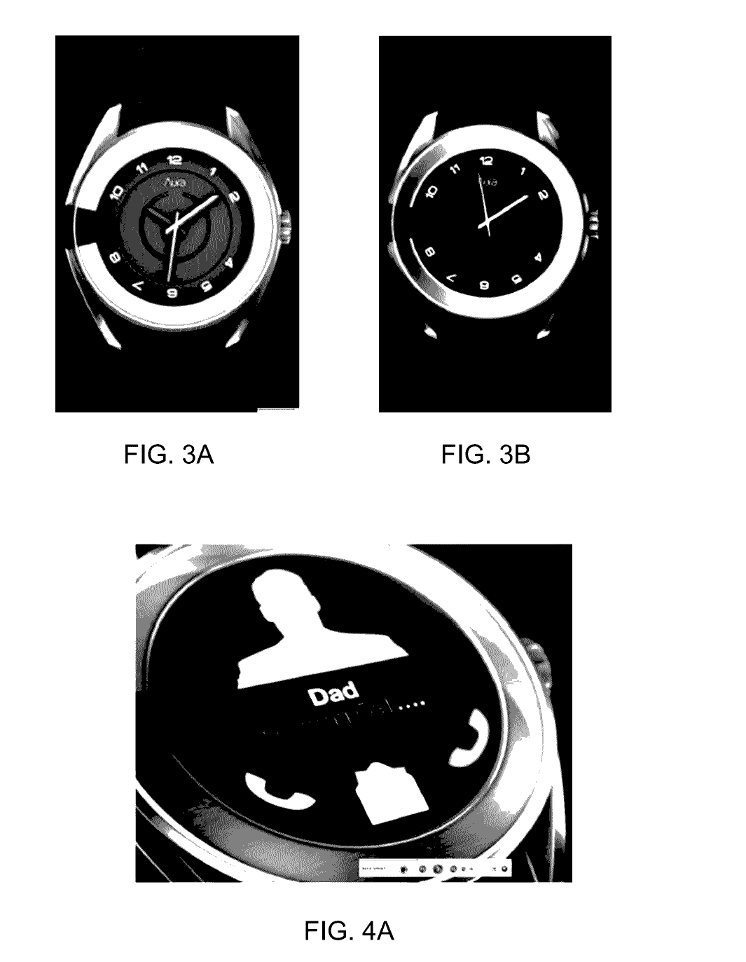

FIGS. 3A and 3B are front elevation views of the watch assembly 10 showing the analog watch 18 with the smart watch overlay 20 in transparent mode showing color combinations that are available for configuring the watch assembly 10 according to embodiments of the invention.

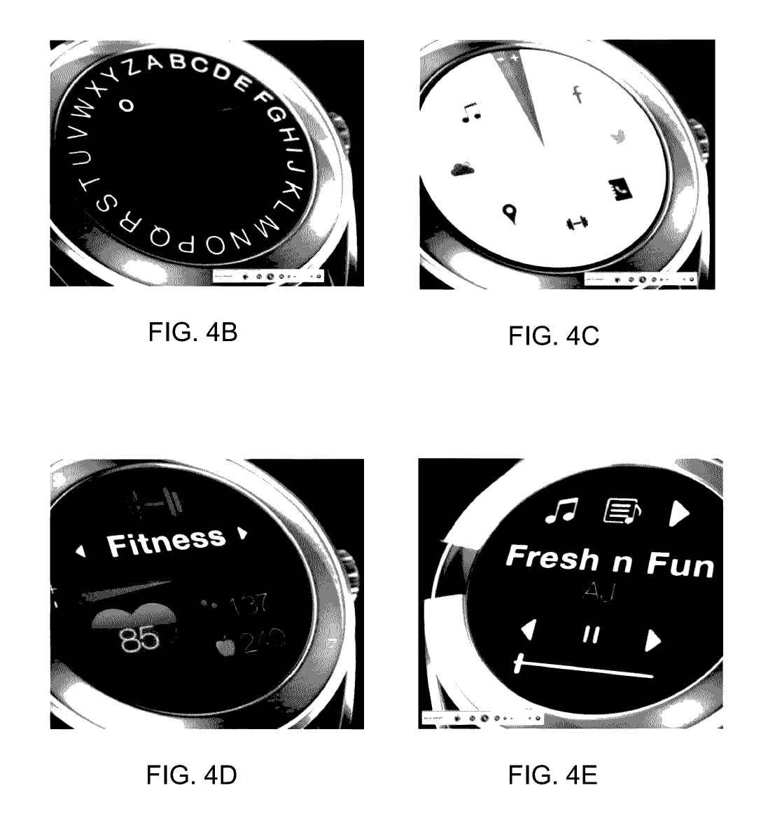

FIGS. 4A and 4E are perspective views of the smart watch overlay screen 20 showing non-limiting examples of application modes including caller identification for cell phone (FIG. 4A), address book (FIG. 4B), application display (FIG. 4C), fitness tracking monitor (FIG. 4D), and music player (FIG. 4E), according to an embodiment of the invention. The various application modes may be written on a software platform or operating system such as, but not limited to, Google Android™, Microsoft Windows™, Apple IOS™, etc., so as to be functional with popular wireless communication devices.

The foregoing description is illustrative of particular embodiments of the invention, but is not meant to be a limitation upon the practice thereof. The following claims, including all equivalents thereof, are intended to define the scope of the invention.

1. A watch assembly comprising:
a watch body with an analog movement;
an overlay touch screen between said analog movement and a watch crystal, said watch crystal configured to seal said analog movement and said overlay touch screen in said watch body, said overlay touch screen having a user adjustable range of transparency modes including a transparent mode, a semitransparent mode, and a full color display mode that conceals said analog movement;
two separate power supplies, wherein each of said overlay display and said analog movement operate on only one of said two separate power supplies; and
a band for securing the watch body to a user.

2. The watch assembly of claim 1 wherein said overlay touch screen is capacitive.

3. The watch assembly of claim 1 wherein said overlay touch screen is configured with organic light-emitting diodes (OLED's).

4. The watch assembly of claim 1 wherein said overlay touch screen is configured with liquid-crystal display (LCD).

5. The watch assembly of claim 1 wherein said watch crystal has a shape that is at least one of circular, oval, square, or rectangular.

7. The watch assembly of claim 1 further comprising a dial, said dial configured for adjustment of said analog movement, as well as of the transparency modes of the overlay display.

8. The watch assembly of claim 1 wherein said overlay display operates on a rechargeable battery as one of said two power supplies and adapted for frequent recharging.

9. The watch assembly of claim 1 wherein during said full color display mode a set of smart watch functions are available.

10. The watch assembly of claim 1 wherein during said full color display mode a set of smart watch functions are available.

11. The watch assembly of claim 10 wherein said set of smart watch functions comprise one or more of syncing with mobile technology, monitoring vitals, geo-positioning (GPS), a music player, ending/receiving calls, controlling other devices via Bluetooth or Wifi, messaging, social networking applications and functions, Internet access, complex notification, a calendar function, a contact system, and an accelerometer and gyrometer.

12. The watch assembly of claim 1 wherein said watch assembly is configurable as at least one of a wearable biometric measuring device, as a location device, or as a payment device.

13. The watch assembly of claim 1 wherein there is interfacing or coupling between a set of digital functions in said full color display mode and said analog movements so that the mechanical movements can be synced or controlled via said digital functions so as to show different times, correct time, or automatically switch between time zones where applicable.

14. The watch assembly of claim 1 further comprising a software platform or operating system.
